(19) United States
(12) Patent Application Publication
(10) Pub. No.: US 2014/0170621 A1
(43) Pub. Date: Jun. 19, 2014

(54) DEVICE FOR TEACHING THE TAKING OF DENTAL X-RAY IMAGES

(71) Applicants: Curtis L. Steward, JR., Sandwich, IL (US); Sean V. Ciesielka, Belvidere, IL (US); Paul K. McDonough, Woodstock, IL (US)

(72) Inventors: Curtis L. Steward, JR., Sandwich, IL (US); Sean V. Ciesielka, Belvidere, IL (US); Paul K. McDonough, Woodstock, IL (US)

(73) Assignee: DENTSPLY INTERNATIONAL INC., York, PA (US)

(21) Appl. No.: 14/081,099

(22) Filed: Nov. 15, 2013

Related U.S. Application Data
(60) Provisional application No. 61/731,628, filed on Nov. 30, 2012.

(51) Int. Cl. G09B 23/28

(52) U.S. Cl. CPC G09B 23/283
USPC 434/263

(57) ABSTRACT

A teaching device 10 includes a radiopaque skull 30 and radiopaque teeth 24, covered with plastic foam and silicone skin 31 to simulate a human head having correct external anatomical form. Pliable lips 20, 21 and other anatomical features realistically reproduce the challenges of taking dental x-rays images.

### TECHNICAL FIELD

The present invention is directed to a device used to teach the taking of dental x-ray images. More particularly, the invention relates to a model or replica of a patient head that mimics human tissue, bone, teeth and the like, as well as correct anatomical movements to simulate that of a real patient.

### BACKGROUND OF THE INVENTION

Devices for teaching the technique of taking a dental x-ray image are known in the art. For example, U.S. Pat. No. 3,520,060 discloses such a device. That patent discloses a natural human skull filled with “a radio equivalent plastic and covered with rubber and plastic-foam sections to simulate a human head.” While this device proved somewhat successful for teaching the taking of dental x-ray images, it required the use of an actual human skull. Further, the '060 patent disclosed a device that used both a foot pedal and a top ratcheting lever to effect movement. The '060 device was also lacking in that it could not accommodate modern x-ray sensors, including for example, phosphor plates, digital sensors or corded sensors, but was limited to the use of film packets only. With respect to jaw movement, the '060 device employed a fixed plate attached to a top lever. A further deficiency of the prior art is the lack of a vertebrae.

Devices such as that of the '060 patent are used for intraoral imaging only. These devices often contain metal parts that would show up as white sections on an x-ray image (underexposed). They have also been found to often contain air pockets that will show up as black areas in x-ray images (overexposed). These devices therefore, cannot be used for extra-oral imaging procedures.

Thus there is a need for a teaching aide or device that more closely mimics human anatomy using a suitable material. Further, there is a need for device employing a singular foot pedal rather than the foot pedal/ratcheting lever of the prior art. A need exists for a device that provides for the use of dental x-ray image sensors, corded sensors, phosphor plates, film packets and the like. There is a further need for a teaching device that mimics correct anatomical jaw movement more closely than is possible with the prior art. The need exists for such a device that is useful as a teaching aide for the taking of dental x-ray images both intraorally and extraorally. The devices and methods of this disclosure address one or more of these needs, as well as other aspects useful to such a device.

### BRIEF DISCLOSURE OF THE INVENTION

The present invention includes a radiopaque, preferably plastic skull and radiopaque preferably plastic teeth covered with foam and/or silicone skin sections to simulate a human head having correct anatomical form. Pliable lips and cheeks and a soft, mobile tongue realistically reproduce the challenges of taking dental x-rays. The head is supported on a chair hook which attaches to dental chairs, or a stand which can be used for table demonstrations. It can be adjusted for various angulations.

To equalize x-ray image exposure and thereby mimic a natural human subject, the present device employs a skull filled with preferably a urethane that has been modified with filler, such as glass beads of calcium carbonate, to reach a desired attenuation level.

### BRIEF DESCRIPTION OF THE DRAWINGS

FIG. 1 is a perspective view of a teaching device according to the present invention.

FIG. 2 is a perspective view of a skull portion of a teaching device as in FIG. 1.

FIG. 3 is a perspective and exploded view of the teeth of the teaching device of FIG. 1.

FIG. 4 is a partially broken, perspective view of the teaching device of FIG. 1 with an attached foot pedal.

FIG. 5 is a perspective view of one portion of the teaching device of FIG. 1.

FIG. 6 is a front elevational, x-ray image taken according to the present invention and employing an embodiment of the teaching device of FIG. 1.

FIG. 7 is a side elevational, x-ray image taken according to the present invention and employing an embodiment of the teaching device of FIG. 1.

### PREFERRED EMBODIMENTS OF THE INVENTION

As shown in FIG. 1, a teaching device according to the present invention is generally designated by the number 10. Teaching device 10 substantially replicates the structure, mechanical operation and radioopacity of a human head (not shown). As such, teaching device 10 has a forehead 11, hair covering 12, ears 13, eyes 14, nose 15, upper lip 20, lower lip 21, upper jaw 22, lower jaw or mandible 23, teeth 24 and neck 25. In addition eyebrows 26 and eyelashes 27 may be provided. As shown in FIG. 2, teaching device 10 has an inner skull 30 that is optionally yet preferably covered with synthetic skin covering 31 and the other portions of a normal human head as shown in FIG. 1. Skull 30 has in addition to teeth 24, an upper gum 32 and a lower gum 33. In short, the structure of teaching device 10 mimics or replicates that of a human head.

As with normal human teeth, teeth 24 according to the invention are each preferably provided with a crown 40 and root 41 (FIG. 3) of teeth to simulate a normal adult dentition with 32 complete teeth. A pediatric version of the device 10 would be provided with a different number. The teeth 24 can be molded with a thermoset plastic resin with from about 30 wt % to about 70 wt % filler comprised of calcium or similar radiopaque material such as a metal including for example, steel, copper, tungsten, or other high specific gravity fillers suspended throughout to simulate radioopacity of human anatomy when x-rayed with traditional x-ray film, phosphor plates, digital sensors and the like. As will be understood by a dental practitioner, teeth 24 may be encompassed in radiolucent material to simulate non-erupted tooth buds and periodontal ligaments (not shown).

As indicated above, skull 30 is configured to replicate a normal human adult. Skull 30 can be molded with a thermoset plastic resin with from about 10 wt % to about 50 wt % filler comprised of calcium or similar radiopaque material such as a metal including for example, steel, copper or tungsten or other high specific gravity fillers suspended throughout to simulate radioopacity of human anatomy when x-rayed with traditional x-ray film, phosphor plates, digital sensors or the like. The specific gravity of the material used for bone in skull 30 is preferably about 20% to 60% less than that used for teeth 24 to provide an accurate contrast simulation of bone versus teeth. Skull 30 may use plastic foam combined with aforementioned high specific gravity fillers to simulate the cellular structure of cancellous bone in normal human anatomy.

A thermoset material is preferably used to provide support and protect teeth 24 in the skull 30 and prevent them from loosening during use. This may also be accomplished by coating the teeth 24 with a radiolucent plastic composition; additionally, the molars (24b in FIG. 3) may be coated on occlusal surfaces with a plastic material for further protection.

In order for teaching device 10 and its skull 30 to mechanically function substantially like a normal human head, the condyle joint 50 is used as a pivot point for the mandible or lower jaw 23. The mandible 23 is joined to the skull 30 at the condyle 50 with a thermoset adhesive with elastomeric properties. This allows the mandible 23 to hinge while maintaining the connection to skull 30 which simulates human anatomy. This also maintains the integrity of natural occlusion with the teeth 24. A long elastomeric strip 51 of rubber, neoprene, silicone or similar material is used to provide constant tension to keep the mandible 23 in the closed position and hold to x-ray positioning devices (not shown) during training activities.

As shown in FIG. 4, a foot pedal 60 with a flexible metal or plastic cable 62 that is operatively attached to the mandible 23 facilitates opening of the mandible 23. This allows the user hands-free operation to more naturally simulate live patient interaction. Foot pedal 60 is preferably designed such that about a 1″ travel of the foot pedal 60 translates to about a 1″ 3/4″ opening of the mandible 23.

To support skull 30 in a manner simulating a normal human anatomy, a neck rod 70 is attached to the skull 30 with a thermoset plastic or similar material. The neck rod 70 allows 360 degrees of full rotation and incorporates a pivot point 71 at its base to allow about 15 to 35 degrees vertical angulation of the head similar to a live patient. A cable 72 is routed through the neck-rod 70 to maintain proper position and function.

Skull 30 is preferably covered in a compressible plastic foam to assist the outer skin 31 in presenting a natural human appearance, provide protection to the skull 30, and to better simulate the feel of human soft tissue.

Skin 31 uses realistic feeling elastomeric components such as silicone or similar materials to mimic the feel and stretch of natural skin. The skin may be made in a single piece or multiple pieces. Skin 31 is decorated to simulate the hair 12, eyebrows 26, and eyelashes 27 to make the device 10 more realistic and representative of a global population.

One alternative version of the device may be a plastic or calcium skull 30 filled and encapsulated with a thermoset material with filler to modify specific gravity of base material to simulate soft tissue on extraoral radiograph imaging systems. The combination of encapsulating materials and skull 30 in the training device 10 is such that it works with imaging equipment designed for use on humans.

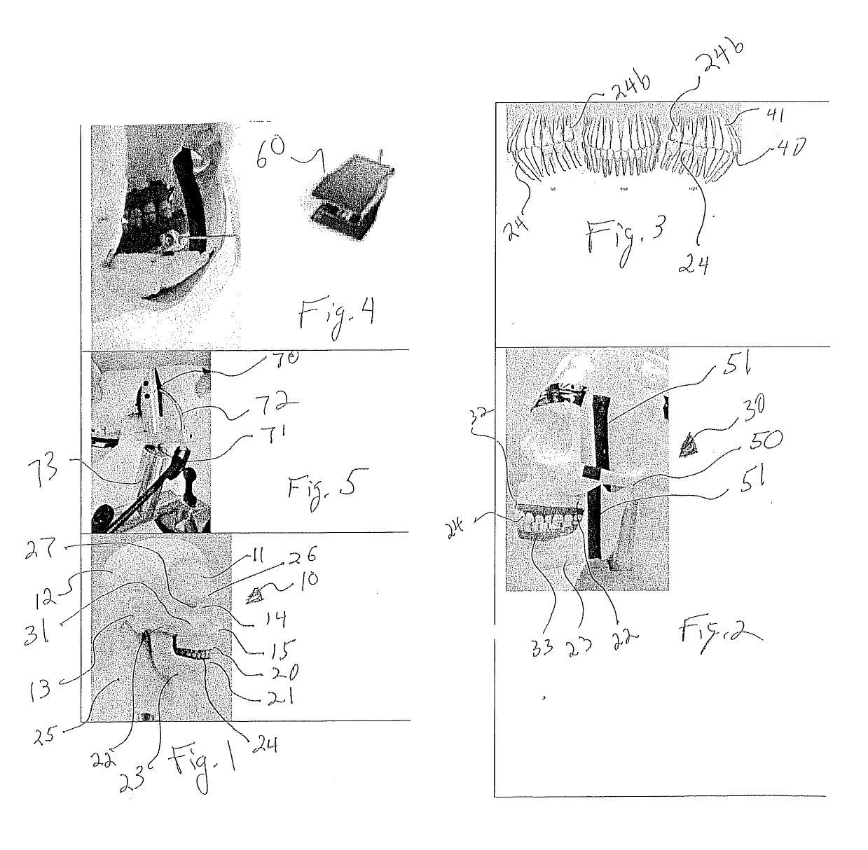

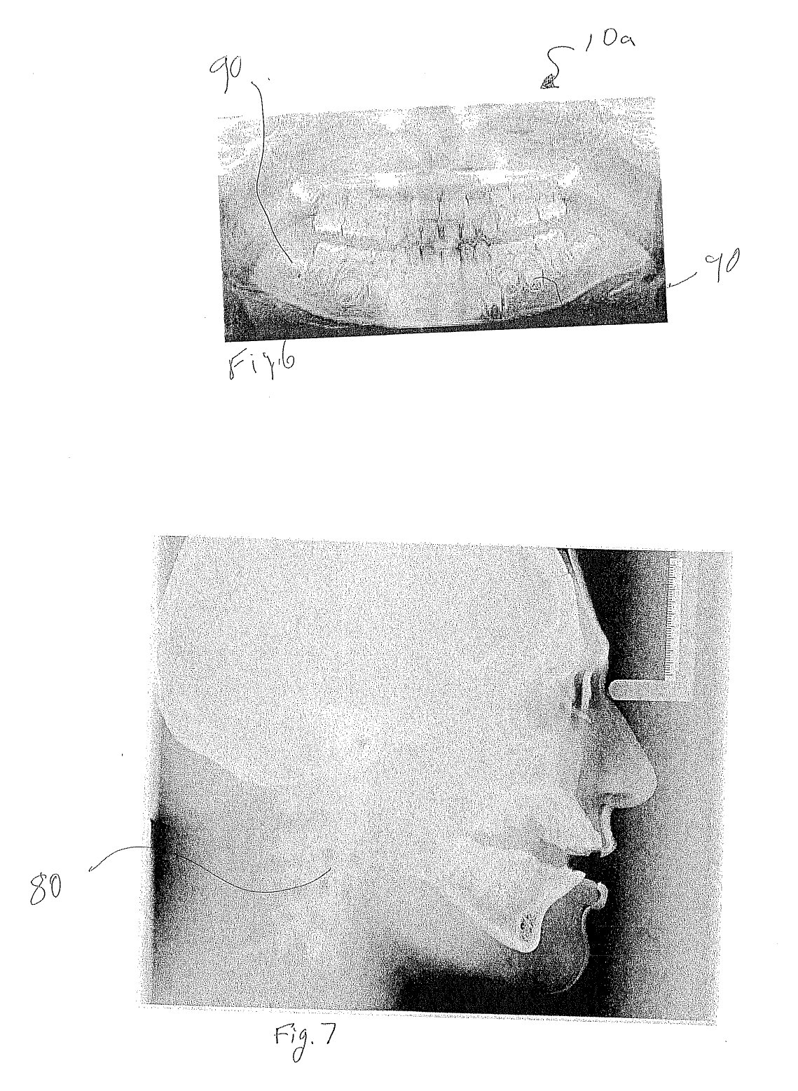

It will be appreciated that the device 10 according to the invention has no moving parts. The “mouth area” including mandible 23, lips 32 and 33, and the like, can be positioned in a slightly open position so that incisal edges are touching. When mounted on an appropriate stand 73 (FIG. 5), the device 10 is useful for taking intra-oral and extra-oral radiographic images. Device 10 may also be provided with vertebrae 80 as shown in FIG. 7 which shows a cephalo-image using the device 10 as herein described.

In a preferred manufacturing operation, teeth 24 as described above are molded into the skull 30 as also above described. The foam (which may be one or multiple pieces) as described above is molded and bonded together and to the skull 30. The final skin 31 as described above is preferably molded and bonded together on the device 10 in a manner that allows the skin 31 to move and stretch realistically.

It will be appreciated that the use of calcium carbonate, preferably in the form of powder or glass beads or the like, or similar radiopaque fillers allow the molded pieces described above to simulate human bone, dentin and enamel in dental x-ray imaging procedures. Natural materials such as human bone, teeth or the like may also be used in the present invention.

There is preferably provided according to the invention, an adult sized teaching device 10 and an appropriately sized pediactric version. Because bone between adults and children are different, the invention simulates both versions. For example, in the adult-sized embodiment of the invention, bone material (used to fabricate skull 30 and mandible 23) is preferably a polyurethane epoxy having a calcium carbonate of up to about 30 wt % filler. The material used to fabricate the teeth of the adult-sized device 10 may also be an epoxy with a urethane or other castable material component, together with from about 20 to about 80 wt % filler. The filler in the teeth may also be a calcium carbonate or the like. To manufacture the adult-sized embodiment of the present invention, it is preferred to mold the teeth first, place them into a skull mold and mold the “bone” material over the teeth.

In the natural pediatric subjects, cancellous bone, synonymous with trebecular bone or spongy bone, is one of two types of osseous tissue that forms bone. Compared to compact bone, which is the other type of osseous pediatric tissue, it has a higher surface area but is less dense, softer, weaker and less stiff. The present invention simulates such material and also simulates the periodontal ligament which is normally not very radiopaque in human subjects.

A preferred pediatric tooth material an epoxy having from 95 wt % to 110 wt % filler such as calcium carbonate. The pediatric bone material preferably an epoxy mix of an aluminum filled castable epoxy mixed at 100 of a first component and about 10 parts of a second, with up to about 200 wt % of an expanding foam and about 15 to 30 wt % of a filler such as calcium carbonate. Suitable pigments or coloring agents may also be used if desired to simulate natural human anatomy. If desired, components not in the x-ray field, such as the skull cap may be made from a different material, such as a urethane plastic.

The pediatric embodiment of the present invention designated as 10a in FIG. 6, also simulates un-erupted teeth 90 as such would be found in children. This may be achieved by coating radiopaque plastic teeth with one or more layers of a radiolucent material.

It should be apparent therefore, that a teaching device as described is an advantageous improvement over the known art. The invention has been described herein and with reference to the drawings for exemplary purposes only. All embodiments which will be evident to the person of ordinary skill in the art have not necessarily been described but all are still within the scope of this disclosure.

What is claimed:

1. A device used to teach the taking of dental x-ray images comprising a synthetic or calcium-based radiopaque skull and radiopaque teeth covered with a synthetic skin to simulate a human head having correct anatomical form

2. A teaching device as in claim 1, further comprising pliable lips and cheeks and a soft, mobile tongue.

3. A teaching device as in claim 1, wherein said skull is supported on an attachment means for supportive affixing to a surface.

4. A teaching device as in claim 3, wherein said attachment means is adjustable so as to reposition said skull.

5. A teaching device as in claim 3 wherein said attachment means includes a rod affixed to said skull.

6. A teaching device as in claim 5 wherein said rod allows said skull to be rotated 360 degrees.

7. A teaching device as in claim 5 wherein said rod has a pivot point at a base thereof to allow said skull to be pivoted 15 to 35 degrees of vertical angulation.

8. A teaching device as in claim 1 wherein said skull is at least partially covered with a compressible foam to simulate human tissue.

9. A teaching device as in claim 1 wherein said skull is fitted with at least one vertebra simulating a human vertebra.

10. A teaching device as in claim 9 wherein said vertebrae is made of a synthetic material.

11. A teaching device as in claim 1 wherein said teeth simulate adult teeth.

12. A teaching device as in claim 1 wherein said teeth simulate pediatric teeth.
